(19) United States
(12) Patent Application Publication
(10) Pub. No.: US 2026/0137491 A1
(43) Pub. Date: May 21, 2026

(54) CUSTOM WAX RIM FOR DENTAL IMPRESSIONS

(71) Applicant: Zima International, Inc. d/b/a Dandy, New York, NY (US)

(72) Inventors: Kenn Butler, New York, NY (US); Samuel Wainwright, New York, NY (US)

(21) Appl. No.: 19/446,103

(22) Filed: Jan. 12, 2026

Related U.S. Application Data
(62) Division of application No. 18/436,708, filed on Feb. 8, 2024.

(51) Int. Cl. A61C 13/00

(52) U.S. Cl. CPC A61C 13/0019; A61C 13/0004

(57) ABSTRACT

A method according to the disclosure herein includes producing a mold having a base is based on a digital model of a patient mouth, a first mold portion monolithically formed with the mold base and defining a U-shaped recess, and a second mold portion shaped to correspond the U-shaped recess; aligning the first mold portion and the second mold portion; filling the U-shaped recess with a wax; and removing the second mold portion to result in a wax mold comprising the wax, the mold base, and the first mold portion.

### CROSS-REFERENCE TO RELATED APPLICATIONS

This application is a divisional of and claims priority to U.S. patent application Ser. No. 18/436,708, filed on Feb. 8, 2024, the contents of which are hereby incorporated by reference in their entirety.

### BACKGROUND

Conventionally, the collection of a dental impression (e.g., a negative outline of a portion of a patient's jaw) is an important step in manufacturing a denture or other bespoke dental appliance. These impressions are commonly produced by the patient biting down onto wax or similarly-impressionable material.

### BRIEF DESCRIPTION OF THE DRAWINGS

FIG. 1 is a perspective view of a mold base, a mold top, a wax rim, and a dental insert.

FIG. 2 is a perspective view of the mold base of FIG. 1.

FIG. 3 is a bottom view of the mold base of FIG. 1.

FIG. 4 is a top view of the mold base of FIG. 1.

FIG. 5 is a rear perspective view of the mold base of FIG. 1.

FIG. 6 is a rear view of the mold base of FIG. 1.

FIG. 7 is a front view of the mold base of FIG. 1.

FIG. 8 is a side view of the mold base of FIG. 1.

FIG. 9 is a perspective view of the mold top of FIG. 1.

FIG. 10 is a bottom view of the mold top of FIG. 1.

FIG. 11 is a top view of the mold top of FIG. 1.

FIG. 12 is a rear perspective view of the mold top of FIG. 1.

FIG. 13 is a rear view of the mold top of FIG. 1.

FIG. 14 is a front view of the mold top of FIG. 1.

FIG. 15 is a side view of the mold top of FIG. 1.

FIG. 16 is a side view of the mold top and mold base of FIG. 1.

FIG. 17 is a perspective view of the mold top and mold base of FIG. 1.

FIG. 18 is a perspective view of the mold top and mold base of FIG. 1.

FIG. 19 is a section view of the mold top and mold base of FIG. 1.

FIG. 20 is a perspective view of a dental insert.

FIG. 21 is a perspective view of a mold for forming the dental insert of FIG. 20.

FIG. 22 is a front view of the mold of FIG. 21.

FIG. 23 is a top view of the mold of FIG. 21.

FIG. 24 is a side view of the mold of FIG. 21.

FIG. 25 is a section view of the mold of FIG. 21 taken along line 25-25 in FIG. 23.

FIG. 26 is a rear perspective view of a bottom portion of the mold of FIG. 21.

FIG. 27 is a perspective view of the mold of FIG. 21 with a base omitted for clarity.

FIG. 28 is a perspective view of the bottom portion of FIG. 25 with the base omitted for clarity.

FIG. 29 is a bottom perspective view of a top portion of the mold of FIG. 21.

### DETAILED DESCRIPTION

Reference will now be made in detail to various embodiments, examples of which are illustrated in the accompanying drawings. While this disclosure includes certain embodiments, it will be understood that the disclosure is not intended to limit the claims to these embodiments. On the contrary, the disclosure is intended to cover alternatives, modifications, and equivalents, which may be included within the spirit and scope of the claims. Furthermore, in this detailed description, numerous specific details are set forth in order to provide a thorough understanding. However, one of ordinary skill in the art will appreciate that the subject matter of the present disclosure may be practiced without these specific details. In other instances, well known methods, procedures, and components have not been described in detail as not to unnecessarily obscure aspects of the present disclosure.

Various embodiments of this disclosure include a custom-fit insert that is shaped to snugly fit on a patient's edentulous jaw and, when the patient bites down on the insert, the bite generates an impression of the patient's opposite jaw. By custom-fitting the insert to the patient's mouth, the insert ensures that the resultant impression is accurate and reduces a risk of poor occlusion for the dentures built based on the impression. Occlusion—how teeth from upper and lower jaws fit together—is a crucial factor in denture manufacture, as poor or inaccurate occlusion can cause unintended wear to the dentures or tooth pain for the patient, in addition to being aesthetically unpleasant. Accordingly, a device that reduces the risk of poor occlusion without adding an additional step to the already-lengthy process of denture manufacture is advantageous.

However, a primary obstacle to bespoke inserts has been that the wax (or similarly-impressionable material) is unable to be additively manufactured (e.g., 3D printed) due to its relatively low melting point. Because this low melting point is also the reason why wax is such an effective material for generating dental impressions, it has been difficult to design around this constraint. The present disclosure overcomes this limitation by additively-manufacturing a bespoke base (that is configured to snugly fit within a patient's mouth) within a top that is shaped to mate with the bespoke base. By then defining a U-shaped (e.g., to trace the dental arch) slot in each component, the base and top collectively define a cavity, when coupled. This cavity is then filled with liquid wax. Once the wax has hardened, the mold top is removed, and the resultant product is the bespoke base with a U-shaped amount of wax that aligns with a patient's tooth-line, such that the patient may position the base against one (i.e., edentulous) jaw and the wax will be positioned over the teeth of the patient's opposite jaw.

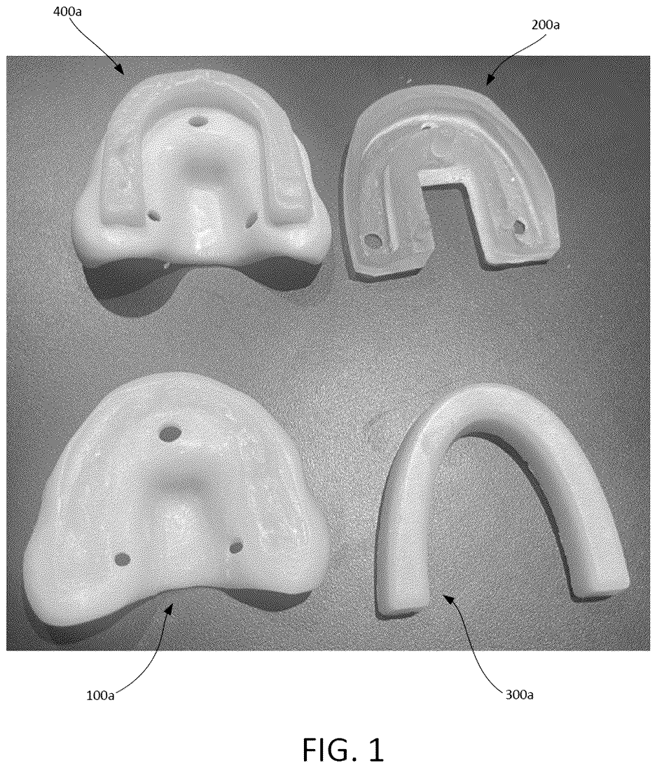

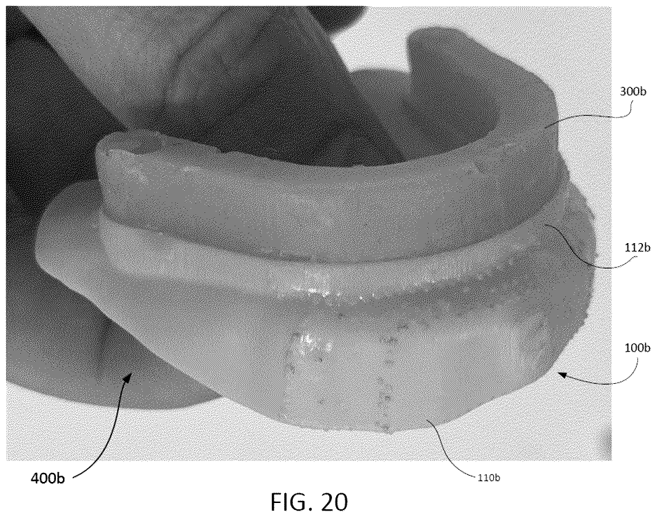

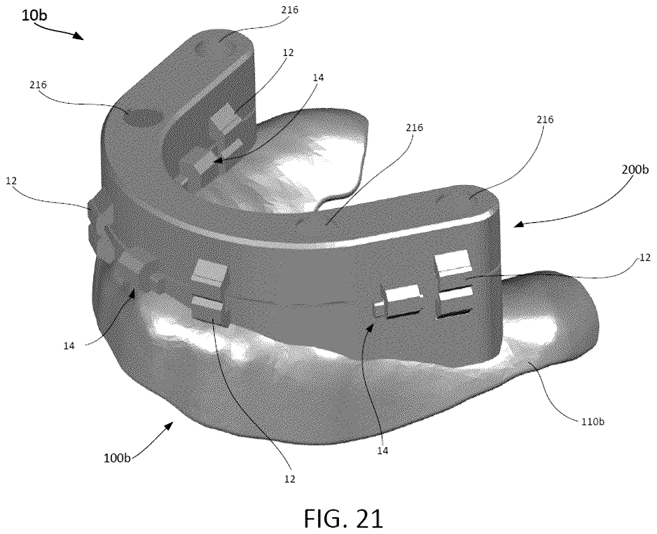

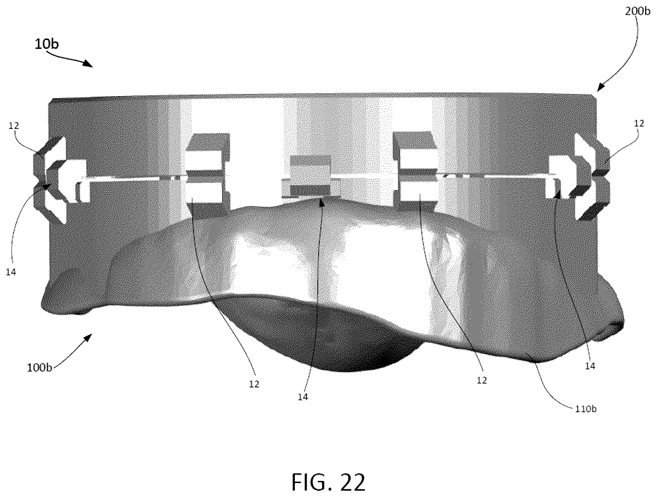

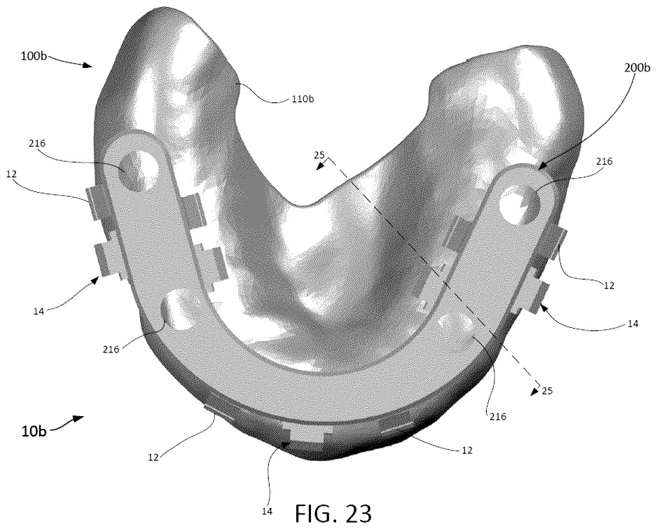

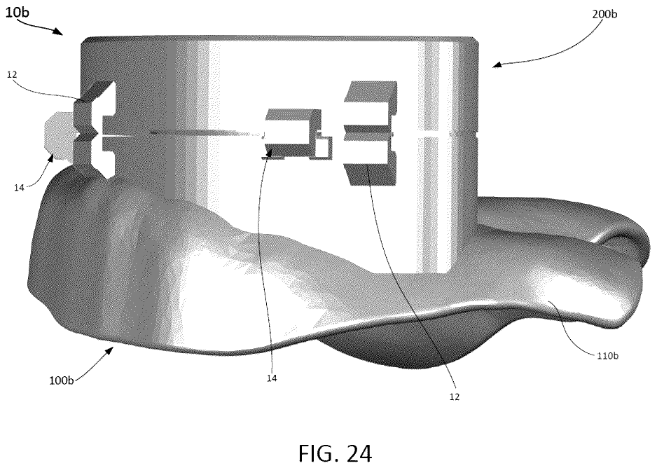

FIG. 1 shows each component involved in the present system: mold base 100a, mold top 200a, wax rim 300a, and insert 400a. The insert 400a may be a combination of base 100a and wax rim 300a, such that the insert 400a is the ultimate result of the method described herein. FIG. 20 shows an alternative insert 400b formed using similar components, shown in FIGS. 21-29.

Each of the mold base 100a and the mold top 200a may be additively-manufactured using a material that is suitable for three-dimensional printing and is safe for use within a patient's mouth. Accordingly, the melting temperature (e.g., melting point) of the material used for the mold base 100a and the mold top 200a may be higher than the melting temperature (e.g., melting point) of the wax rim 300a, as wax is generally incapable of being three-dimensionally printed.

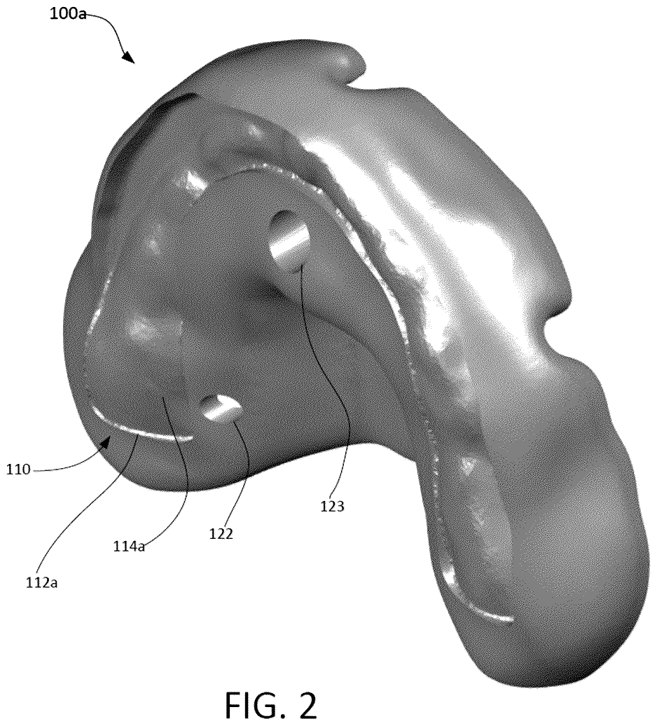

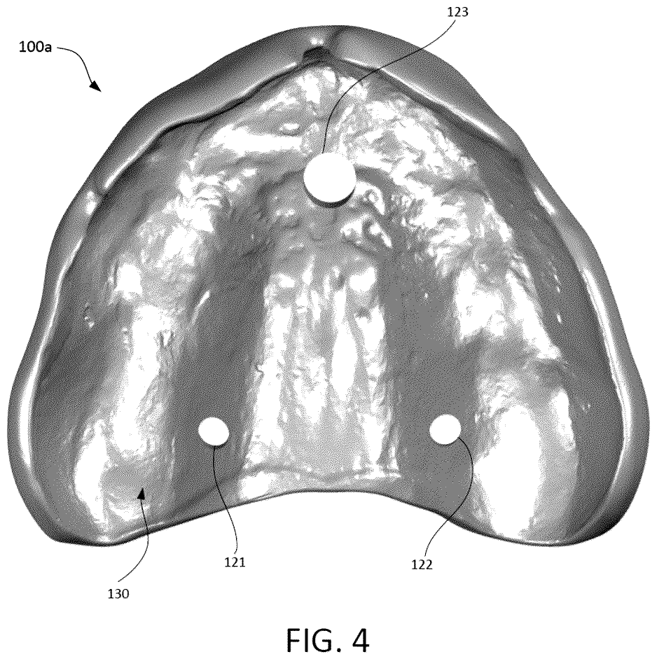

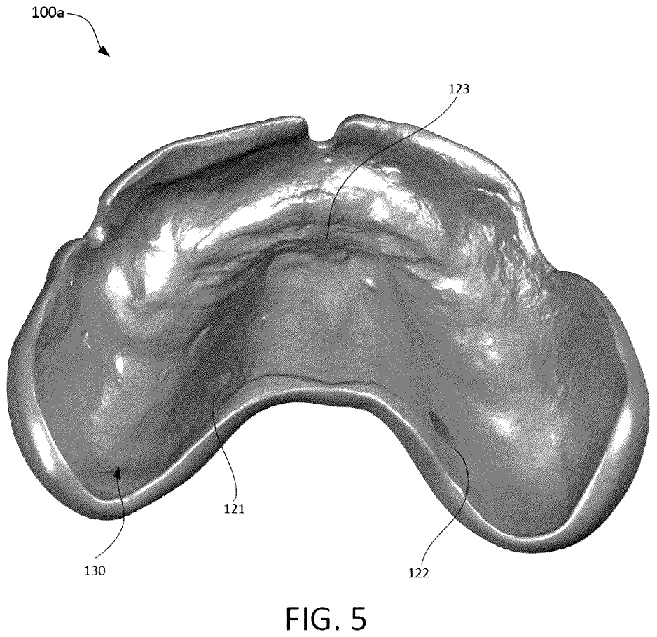

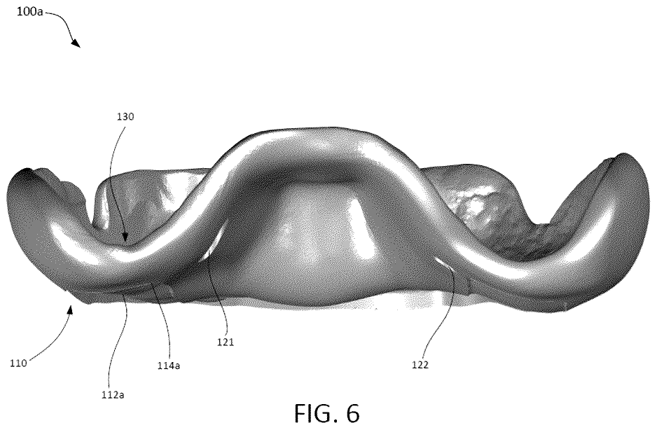

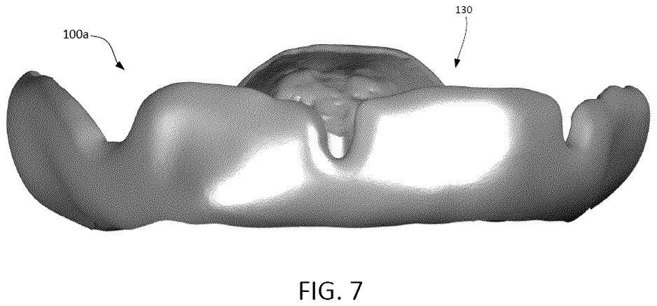

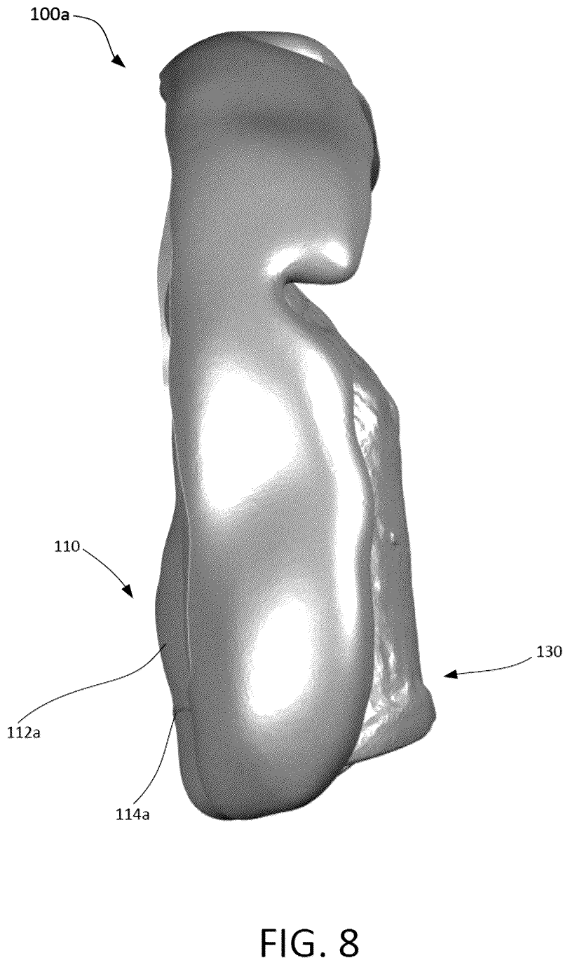

FIGS. 2-8 show various views of the mold base 100a. In the embodiments shown, the mold base 100a is shaped to snugly fit with an edentulous upper jaw (e.g., a toothless gum), such that the impression to be formed by the insert 400a is of the lower jaw. Accordingly, reference will be made throughout to the upper jaw and the lower jaw for clarity, but this disclosure should not be read as limited to use of the insert 400a in this manner. For example, this disclosure should be read as applicable to the mold base 100a shaped to fit about an edentulous lower jaw to take an impression of the upper jaw.

As shown, the mold base 100a may include an outer face 110 and an inner face 130. In some embodiments, the mold base 100a may be produced through additive-manufacturing by designing a three-dimensional digital model defined by the negative space around the patient's edentulous upper jaw (e.g., the patient's gum). This model may be designed using an oral scan of the jaw using any suitable method (e.g., CT scan, an MRI, optical scan, etc.). The inner face 130 may be defined as an exterior of the upper jaw, and the outer face 110 may be defined as a preset thickness of material from the inner face 130.

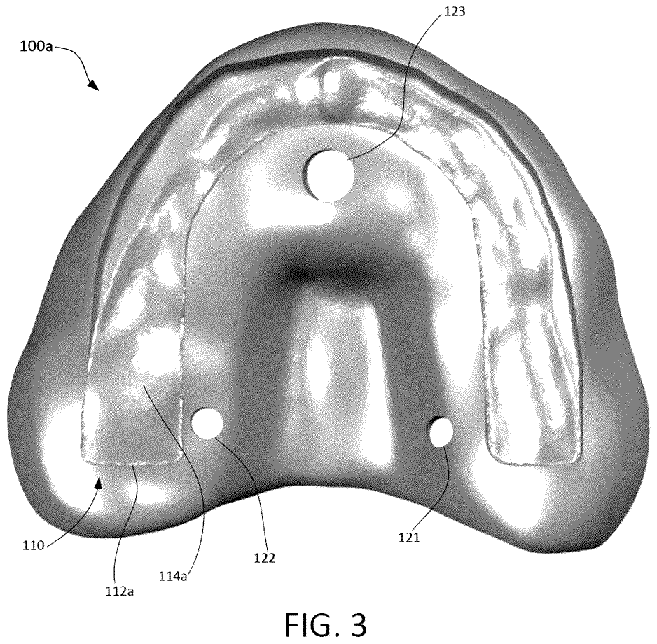

The outer face 110 may include having a molded edge 112a and a wax recess 114a. The wax recess 114a may be generally U-shaped (e.g., a bottom surface of the recess 114a is U-shaped relative to the bottom view of FIG. 3) and configured to align with a dental arch of the lower jaw. In order to construct the wax recess 114a within the mold base 100a without milling or similar techniques, the wax recess 114a may be included in the digital model by digitally-removing the portion of the model (e.g., by digitally inserting a single U-shaped “tooth” on the outer face 110). The wax recess 114a may have substantially-constant wall angles (e.g., the wax recess 114a may have right angles within the recess 114a), which may define the molded edge 112a as non-uniformly curved to correspond with the bespoke shape of the patient's upper jaw. The shape of the molded edge 112a is relevant to production of the wax rim 300a, which is discussed in depth below with reference to mold top 200a.

The mold base 100a may include one or more apertures (e.g., holes). The illustrated embodiment includes three such apertures: first aperture 121, second aperture 122, and third aperture 123. Each aperture may be formed as part of the digital model, such that the mold base 100a may be printed with the apertures included, and the apertures may extend through the entire mold base 100a. As described below with reference to the mold top 200a, the apertures may be used to align the mold base 100a with the mold top 200a.

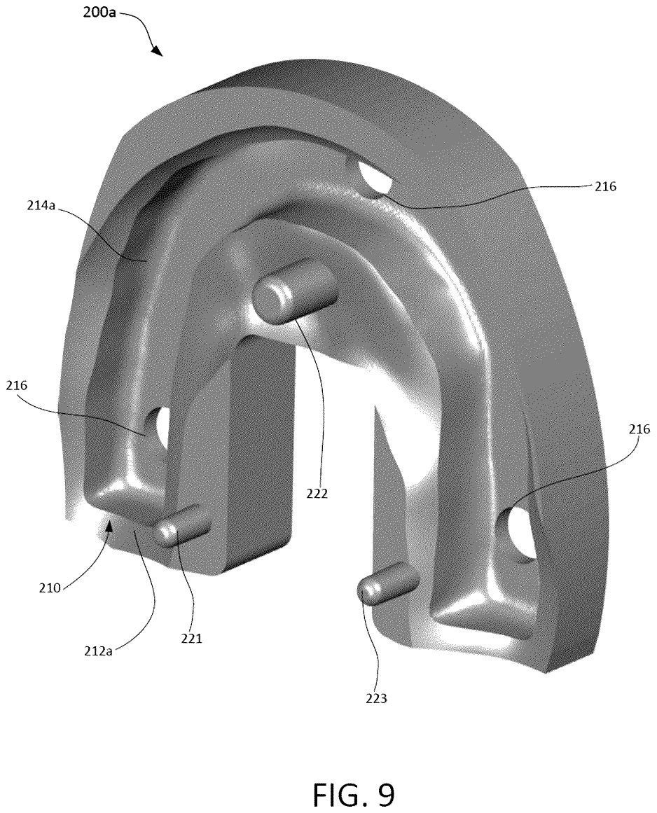

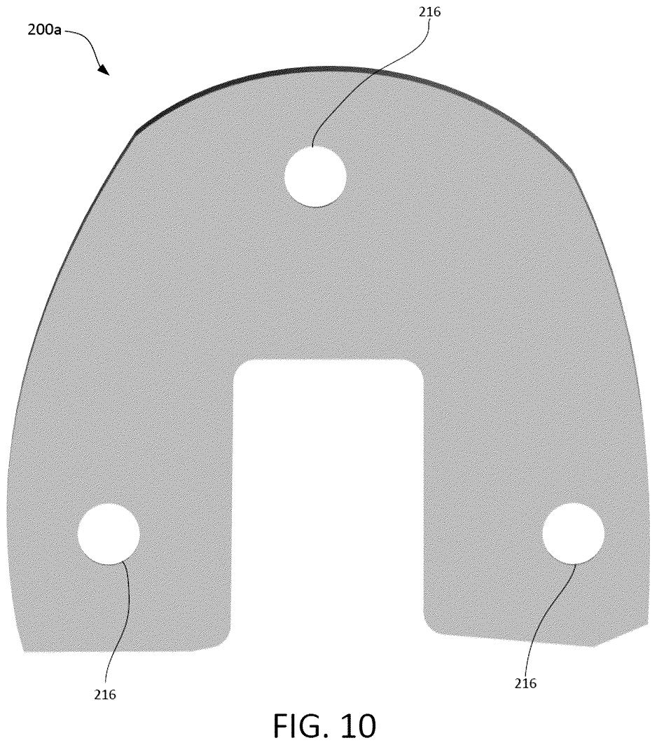

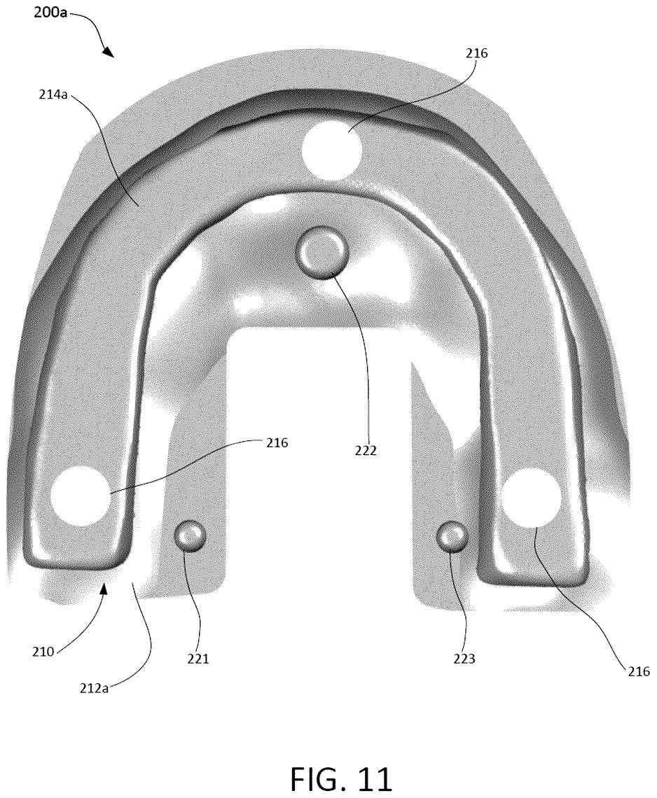

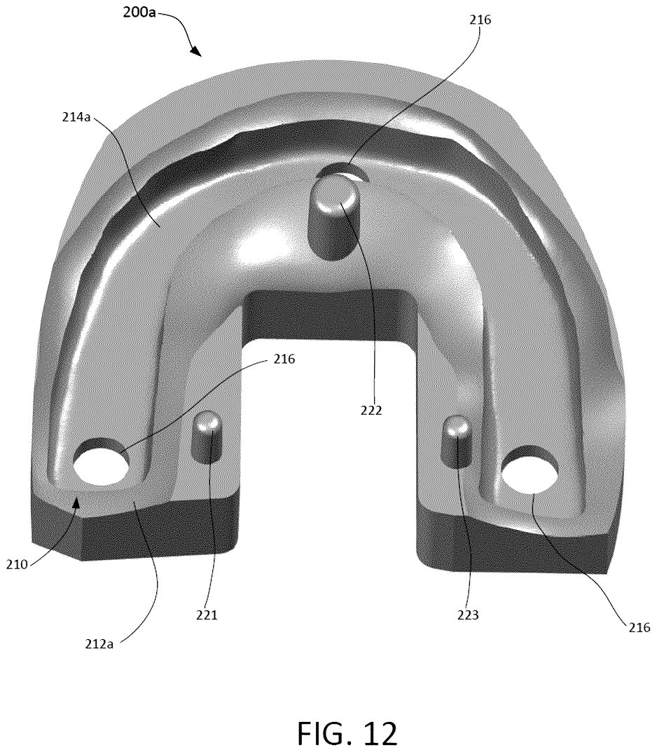

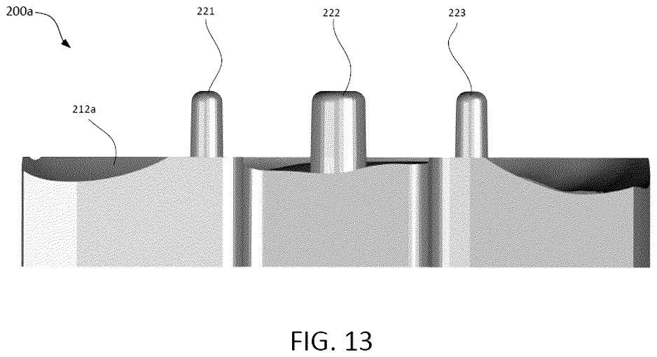

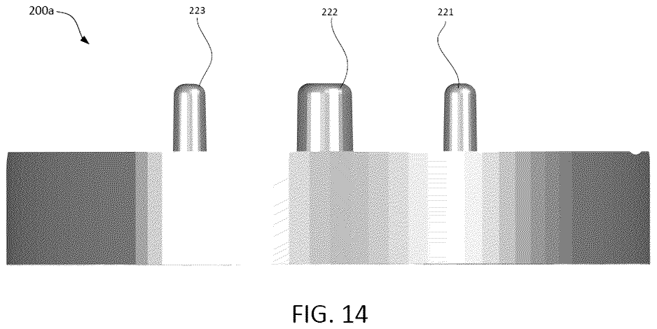

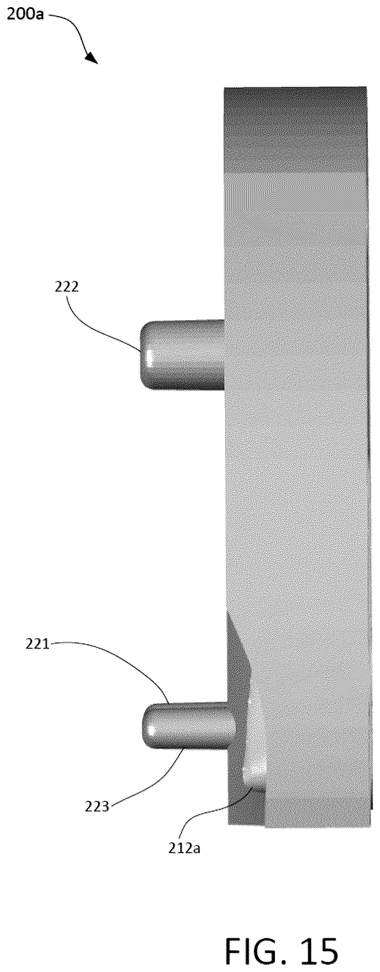

FIGS. 9-15 show various views of the mold top 200a. As shown, the mold top 200a may include a surface 210 having a wax recess 214a and a molded edge 212a about the perimeter of the wax recess 214a. The shape (e.g., outline, impression, etc.) of the wax recess 214a may be a mirror image of the wax recess 114a of the mold base 100a (e.g., relative to the views of FIGS. 3 and 11), such that when the surface 210 of the mold top 200a abuts the outer face 110 of the mold base 100a, the wax recess 114a and wax recess 214a collectively form a cavity.

This cavity may be substantially sealed (e.g., only allowing liquid to flow into the cavity via one or more holes 216) by the interface of the molded edge 112a of the mold base 100a with the molded edge 212a of the mold top 200a. To ensure a consistent and reliable seal, the mold top 200a may be additively-manufactured based on a digital model designed as the negative space of the mold base 100a. In particular, the shape and contour of the molded edge 212a may be designed (e.g., in the digital model) as the negative space of the molded edge 112a. Put differently, the mold base 100a may be designed based on the negative space of a patient's edentulous jaw, and the mold top 200a may be designed based on the negative space of the mold base 100a.

Once the mold base 100a and mold top 200a are aligned, wax (or similar material suitable for taking dental impressions) may be injected into the cavity via the one or more holes 216. Because the cavity is otherwise sealed (e.g., other than the holes 216), the wax may fill the cavity and eventually harden as wax rim 300a. This fully assembled combination (e.g., the mold base 100a and mold top 200a on either side of the wax rim 300a) may be delivered to the dental technician responsible for taking the impression as a single unit. By removing the mold top 200a, the insert 400a may be ready to be positioned within the patient's mouth for taking an impression of their lower jaw.

As shown, the mold top 200a may include one or more protrusions (e.g., pegs). The illustrated embodiment includes three such protrusions: first protrusion 221, second protrusion 222, and third protrusion 223. Each protrusion may extend perpendicularly from the surface 210 and may be configured to fit within a corresponding hole of the mold base 100a. In particular, the first protrusion 221 may be sized, shaped, and positioned to fit within the first aperture 121; the second protrusion 222 may be sized, shaped, and positioned to fit within the second aperture 122; and the third protrusion 223 may be sized, shaped, and positioned to fit within the third aperture 123. In this manner, although three pairs of protrusions and holes are shown, it should be understood that any number of pairs may be read as within the scope of this disclosure, provided that the number of pairs provided is sufficient to ensure alignment between the mold base 100a and the mold top 200a.

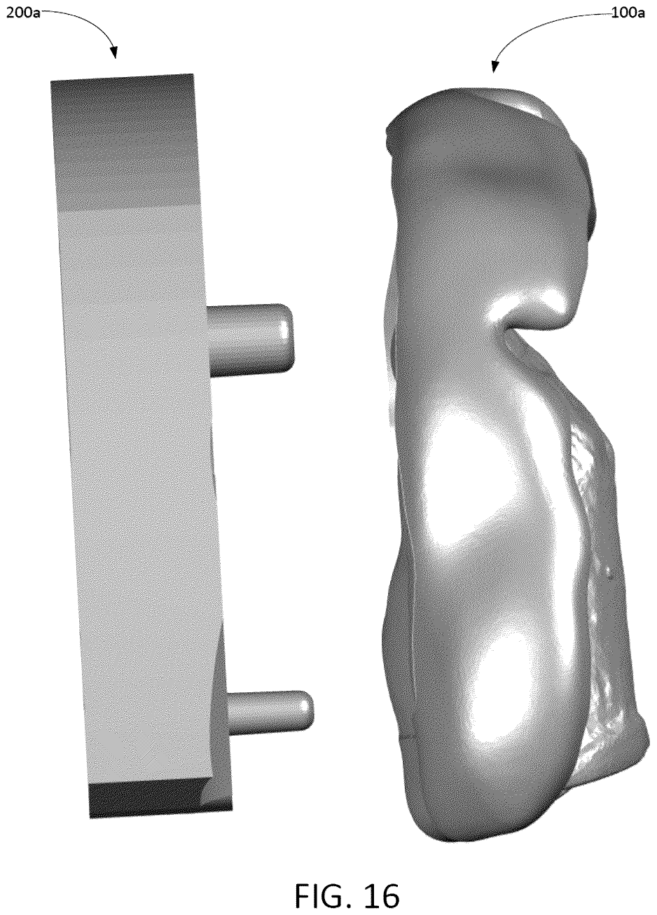

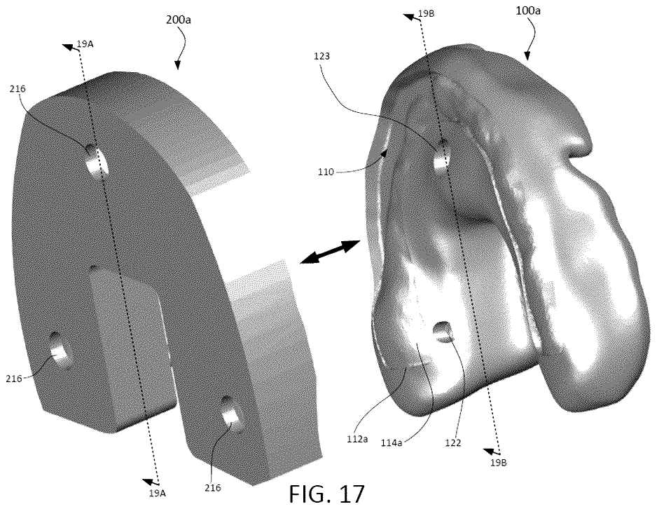

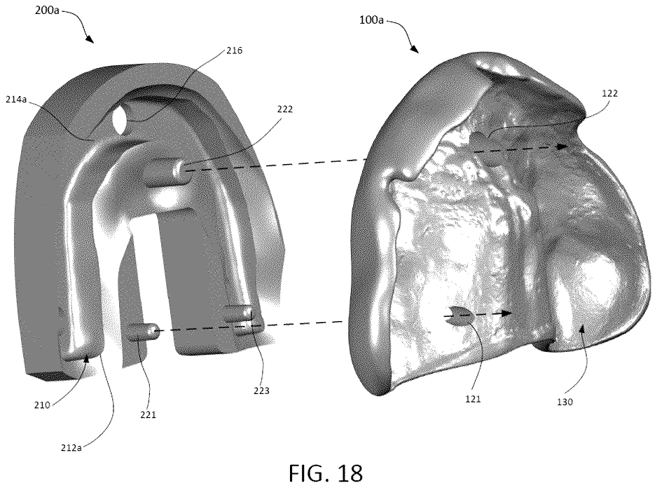

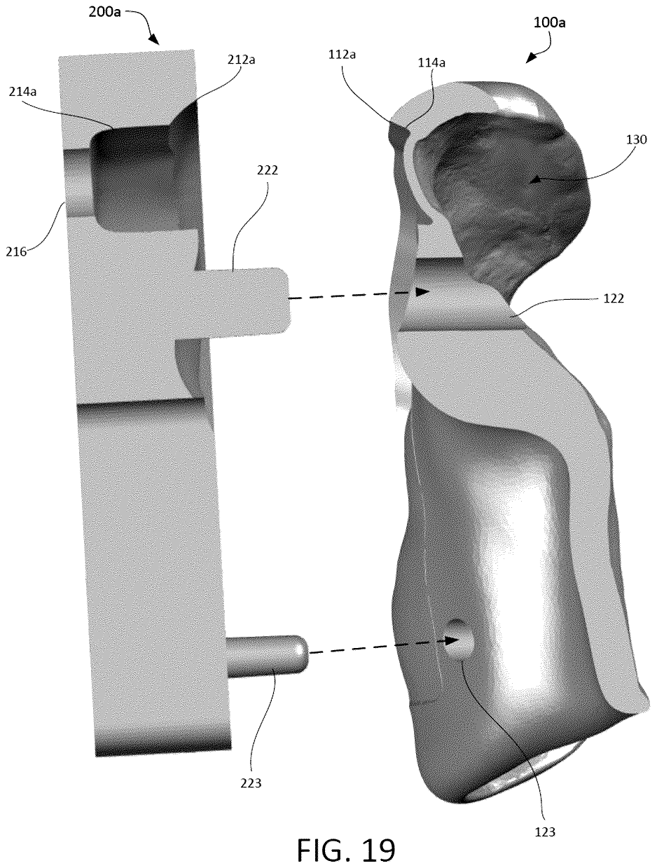

FIGS. 16-19 show various views of the mold base 100a and the mold top 200a in alignment for the fully assembled combination. As shown, protrusions 221, 222, and 223 of the mold top 200a may be inserted into corresponding apertures 121, 122, and 123, which causes molded edge 212a to form a seal with molded edge 112a and defines the cavity for receiving wax with the wax recess 114a and wax recess 214a. FIG. 19 shows a section view of this combination, taken along lines 19A-19A and 19B-19B of FIG. 17.

FIG. 20 shows a dental insert 400b configured—like dental insert 400a—to be positioned on a patient's edentulous gum in order to take an impression of the opposite gum. Dental inserts 400a and 400b are functionally identical, with the primary distinction being that the wax 300a of the dental insert 400a extends to an interior of the base 100a, while the wax 300b of the dental insert 400b extends from a surface of the base 100b, such that a ridge of additional base 100b material formed by molded edge 112b protrudes above a bottom portion of the wax 300b.

As shown in FIGS. 21-24, the mold 10b used to form the dental insert 400b includes a base 100b and a top 200b. Similar to the top 200a, several apertures (or holes) 216 provide access to an interior of the base 100b and top 200b and are configured to receive wax to form the wax 300b portion of the insert 400b.

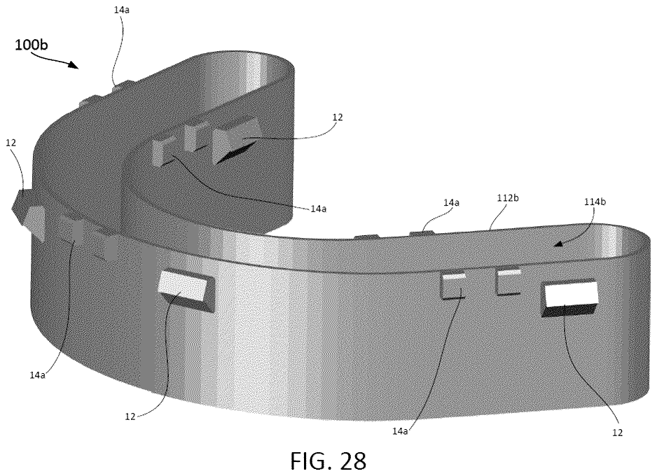

In contrast to the protrusions 221, 222, 223 of the top 200a and the apertures 121, 122, 123 of the base 100a, the base 100b and top 200b may include alignment mechanisms 14 positioned about the seam formed by the corresponding edges of the base 100b and top 200b. As shown, the alignment mechanism 14 may include a pair of alignment protrusions 14a on the base 100b (as seen in FIG. 28) and an alignment protrusion 14b on the top 200b shaped to fit between the pair of alignment protrusions 14a. By positioning these alignment mechanisms 14 at various points about the seam, the base 100b and top 200b may be aligned to each other. Although this particular configuration for the alignment mechanism 14 is shown, this disclosure should not be read as limited to just this configuration and should be read to include any suitable means for aligning the base 100b and top 200b. For example, the alignment mechanism 14 could be a snap-fit detent with corresponding protrusion, a male-female friction fit, etc.

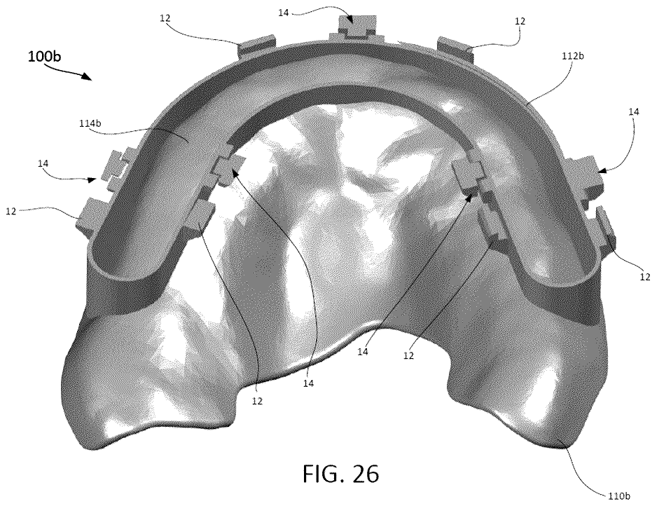

Referring now to FIG. 26, another difference between base 100a and base 100b is shown. In contrast to the recess 114a being formed by the absence of material in the base 100a and the molded edge 112a being formed as the rim of the recess 114a, the molded edge 112b is formed by an extension of material away from the gum-shaped portion 110b of the base 100b and the recess 114b is defined as the interior of this raised material. In this manner, the molded edge 112b is substantially flat (e.g., the highest points of the molded edge 112b exist on a same horizontal plane), and the bottom surface of the recess 114b is contoured to the patient's gum. Consequently, the corresponding molded edge 212 b of the top 200b is similarly flat, such that the seal created by the interaction of the two molded edges 112b, 212b is formed by the abutment of two flat edges rather than the bespoke curvature of molded edges 112a, 212a.

The base 100b and top 200b are designed such that both components may be additively-manufactured as a single monolithic piece, with the base 100b and top 200b joined by sacrificial couplings 12. These couplings 12 are configured to be cut, snapped, or otherwise broken or removed in order to separate (e.g., detach) the two components. Given that the recesses 114b, 214b are pre-treated (e.g., lubricated) prior to the wax being injected, it is advantageous for the base 100b and top 200b to be separately worked. However, it is also advantageous for the base 100b and top 200b to be manufactured in one step to shorten production time and to improve compatibility with various design software and printing technologies. The sacrificial couplings 12 enable both of these advantages by enabling the base 100b and top 200b to be printed together but easily separated in processing.

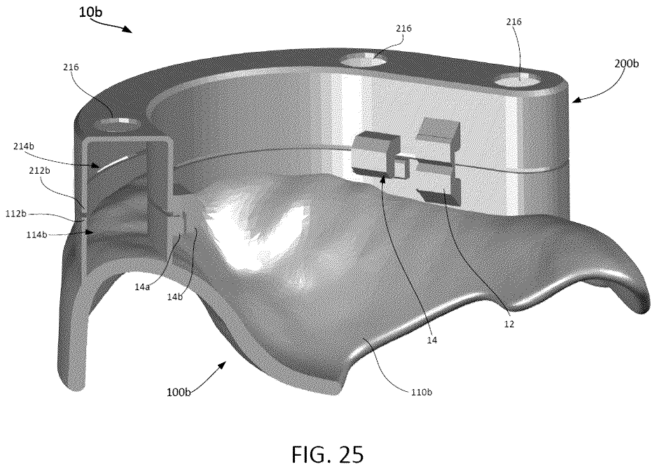

As part of the manufacturing process, the base 100b and top 200b may be manufactured with a small gap between the corresponding edges 122b, 212b. This gap is shown in the section view of FIG. 25 and may not be present once the base 100b and top 200b are separated and aligned for use (e.g., filling with wax).

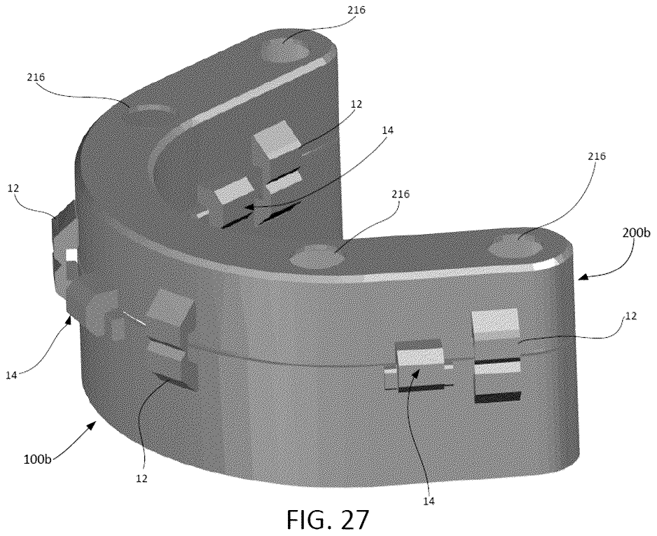

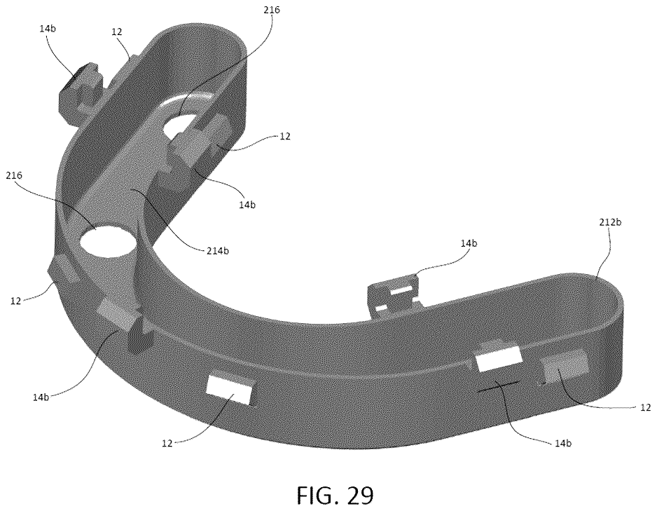

FIG. 27 is a perspective view of the base 100b and top 200b with the gum-shaped portion 110b removed for clarity. In practice, the mold 10b may be designed by scanning a patient's gum to generate a digital model of the gum-shaped portion 110b, and digitally-positioning the base 100b and top 200b within the gum-shaped portion 110b model. The depth of the base 100b within the gum-shaped portion 110b may be based on a desired depth of the wax 300b. FIGS. 28 and 29 are perspective views of the base 100b and top 200b respectively, with the gum-shaped portion 110b omitted in both.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method comprising:
producing a mold comprising:
a mold base that is based on a digital model of a portion of a patient mouth;
a first mold portion monolithically formed with the mold base and defining a first U-shaped recess; and
a second mold portion shaped having a second U-shaped recess corresponding to the first U-shaped recess;
aligning the first mold portion and the second mold portion, wherein the first U-shaped recess and the second U-shaped recess cooperate to form a cavity;
filling the cavity with a wax in liquid form;
solidifying the wax in the cavity; and
removing the second mold portion to result in a wax mold comprising a wax rim formed by the wax in the cavity, the mold base, and the first mold portion.

2. The method of claim 1, further comprising inserting the wax mold into the patient mouth, wherein:
the mold base is configured to form a snug fit with a gum portion of the patient mouth; and
the wax rim is configured to form an impression of a tooth portion of the patient mouth.

3. The method of claim 2, wherein the gum portion is of a first jaw of the patient mouth and the tooth portion is of a second jaw of the patient mouth, the second jaw different from the first jaw.

4. The method of claim 1, wherein the second U-shaped recess is positioned to align with a tooth portion of the patient mouth.

5. The method of claim 1, wherein producing the mold comprises:
additively-manufacturing the mold base, the first mold portion, and the second mold portion as a single component; and
detaching the second mold portion from the first mold portion by removing at least one sacrificial coupling.

6. The method of claim 1, wherein the mold has a higher melting temperature than a melting temperature of the wax.

7. The method of claim 1, wherein filling the cavity with wax comprises injecting wax via at least one aperture in the second mold portion.

8. A method for producing a wax mold for dental impressions, the method comprising:
processing a scan of a patient mouth to generate a gum scan;
producing, via additive manufacturing, a first mold corresponding to the gum scan;
producing, via additive manufacturing, a second mold comprising a recess configured to receive wax and to mate with the first mold;
aligning the first mold and the second mold, such that the recess is substantially sealed by the first mold;
injecting wax in liquid form into the recess;
solidifying the wax in the recess; and
removing the second mold to isolate the wax mold.

9. The method of claim 8, further comprising inserting the wax mold into the patient mouth, wherein:
the first mold is configured to form a snug fit with a gum portion of the patient mouth; and
the wax is configured to form an impression of a tooth portion of the patient mouth.

10. The method of claim 9, wherein the gum portion is of a first jaw of the patient mouth and the tooth portion is of a second jaw of the patient mouth, the second jaw different than the first jaw.

11. The method of claim 8, wherein the recess is positioned to align with a tooth portion of the patient mouth.

12. The method of claim 8, wherein:
the first mold and the second mold are produced as a single component; and
the second mold is configured to detach from the first mold by removing at least one sacrificial coupling.

13. The method of claim 8, wherein the first mold and the second mold comprise a material having a higher melting point than the wax.

14. The method of claim 8, wherein filling the recess with wax comprises injecting wax via at least one aperture in the second mold.

15. A method of manufacturing a dental insert for taking a dental impression, the method comprising:
generating a digital model of a mold base based on a scan of an edentulous jaw of a patient, wherein the digital model includes a U-shaped wax recess on an outer face of the mold base;
generating a digital model of a mold top based on a negative space of the mold base, wherein the digital model of the mold top includes a corresponding U-shaped wax recess;
additively manufacturing the mold base and the mold top;
aligning the mold base and the mold top such that the U-shaped wax recess of the mold base and the corresponding U-shaped wax recess of the mold top collectively form a cavity; and
injecting wax into the cavity to form a wax rim.

16. The method of claim 15, wherein generating the digital model of the mold base includes:
digitally defining a molded edge about a perimeter of the U-shaped wax recess; and
generating the digital model of the mold top includes digitally defining a corresponding molded edge shaped as a negative space of the molded edge of the mold base.

17. The method of claim 15, wherein the scan of the edentulous jaw comprises at least one of a CT scan, an MRI, or an optical scan.

18. The method of claim 15, further comprising removing the mold top after the wax has hardened to produce a dental insert comprising the mold base and the wax rim.

19. The method of claim 15, wherein the dental insert is configured to be positioned against the edentulous jaw of the patient such that the wax rim aligns with teeth of a jaw opposite that of the edentulous jaw to receive a dental impression.

20. The method of claim 15, wherein the mold base and the mold top comprise a material having a higher melting point than the wax.
